(19) United States
(12) Patent Application Publication
(10) Pub. No.: US 2006/0171750 A1
(43) Pub. Date: Aug. 3, 2006

(54) Digital copier with smart printing function and copying method thereof

(75) Inventor: Thomas Sheng, Hsinchu (TW)

Correspondence Address: BIRCH STEWART KOLASCH & BIRCH, PO BOX 747, FALLS CHURCH, VA, 22040-0747, US

(73) Assignee: A VISION INC.

(21) Appl. No.: 11/340,604

(22) Filed: Jan. 27, 2006

(30) Foreign Application Priority Data
Jan. 28, 2005 (TW) 094102809

(51) Int. Cl. G03G 15/00

(52) U.S. Cl. 399/363

(57) ABSTRACT

In a digital copier with smart printing function, a sheet size detection module detects a sheet size of a to-be-printed sheet placed in a tray module and generates a sheet size signal, and a scanning module scans a document to obtain a document image and an image signal corresponding to the document image. After a user has pressed a quick copy button to generate a quick copy signal, an image processing module processes the document image into a first image to fit the sheet size by way of scaling or into a second image to fit the sheet size by way of rotating and scaling according to the quick copy signal, the sheet size signal, the image signal and a document size signal, and thus generates a printing signal. A printing module receives the printing signal to print the first image or the second image on the to-be-printed sheet.

### BACKGROUND OF THE INVENTION

1. Field of the Invention

The invention relates to a digital copier with smart printing function and a copying method thereof, and more particularly to a digital copier, which has a quick copy button and can quickly and automatically output a fitted printing result after a user has pressed the quick copy button once, and a copying method thereof.

2. Description of the Related Art

A conventional digital copier usually has multiple trays in order to meet the requirement of different output sheets. The size of the original is detected, and the to-be-printed sheet corresponding to the size of the original is selected as the printing medium. Alternatively, the to-be-printed sheet and the scaling ratio can be selected manually, and then data can be printed on the to-be-printed sheet.

Although the digital copier has the auto-scaling function, such as that as disclosed in U.S. Pat. No. 5,323,212, many buttons have to be attached in order to meet various output requirements. After the user has pressed the copy button, if there is no to-be-printed sheet meeting the original size is placed in the tray, the copier pauses and asks the user to select the size of the to-be-printed sheet or the scaling ratio. Then, the copier prints data according to the selection of the user. Consequently, the user has to press two or more than two buttons to finish a copying operation. It is quite inconvenient to the user who only wants to make a quick copy without requesting the printed size to be the same as the original size.

One example of facilitating the operation of the user is a point-and-shoot camera, wherein the user only has to press the shutter button, and the camera automatically adjusts the size of the stop and the shutter time and automatically focuses and flashes such that the user does not has to make any complicated setting.

Another example of facilitating the operation of the user is the “One-Click” patent assigned to Amazon, wherein the computer automatically uploads the user data to the corresponding shopping website after the user clicks a shopping button through the Internet. Thus, it is very convenient to the user because he or she does not have to press other buttons.

The minimized digital copiers are used more and more widely by more and more users, some of who may seldom use the digital copier. For example, the copy service provided by a convenience store may be used by a user who is not familiar with the operation. So, the complicated buttons confuse the user and thus decrease the user's intention of using the copier.

### SUMMARY OF THE INVENTION

It is therefore an object of the invention to provide a digital copier with smart printing function and a copying method thereof, wherein the digital copier has a quick copy button, such that a printing procedure containing a smart scaling process and/or an image rotating process is performed after the button has been pressed.

To achieve the above-identified object, the invention provides a digital copier including a tray module, a sheet size detection module, a quick copy button, a scanning module, an image processing module and a printing module. The tray module stores a plurality of to-be-printed sheets. The sheet size detection module detects a sheet size of each of the to-be-printed sheets and thus generates a sheet size signal. The quick copy button generates a quick copy signal after being pressed. The scanning module scans a document to obtain a document image and an image signal corresponding to the document image. The image processing module processes the document image into a first image to fit the sheet size by way of scaling or into a second image to fit the sheet size by way of rotating and scaling according to the quick copy signal, the sheet size signal, the image signal and a document size signal, and thus generates a printing signal. The printing module receives the printing signal to print the first image or the second image on the to-be-printed sheet.

To achieve the above-identified object, the invention also provides a copying method of a digital copier with smart printing function. The method includes the steps of: detecting a sheet size of each of to-be-printed sheets placed in a tray module to generate a sheet size signal; receiving a quick copy signal generated after a quick copy button has been pressed; scanning a document to obtain a document image and an image signal corresponding to the document image; processing the document image into a first image to fit the sheet size by way of scaling or into a second image to fit the sheet size by way of rotating and scaling according to the quick copy signal, the sheet size signal, the image signal and a document size signal, and thus generating a printing signal; and receiving the printing signal to print the first image or the second image on the to-be-printed sheet.

According to the digital copier of the invention, the user can perform a smart copying process by pressing a single quick copy button.

### BRIEF DESCRIPTION OF THE DRAWINGS

FIG. 1 is a schematic illustration showing a digital copier with smart printing function according to a preferred embodiment of the invention.

FIG. 2 is a schematic illustration showing a first example of the digital copier of the invention during the copying process.

FIG. 3 is a schematic illustration showing a second example of the digital copier of the invention during the copying process.

FIG. 4 is a schematic illustration showing a third example of the digital copier of the invention during the copying process.

FIG. 5 is a flow chart showing a copying method of the digital copier of the invention.

### DETAILED DESCRIPTION OF THE INVENTION

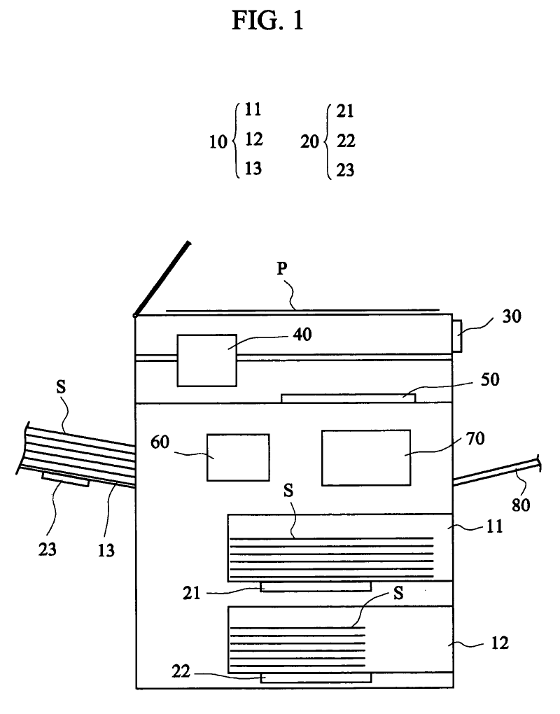

FIG. 1 is a schematic illustration showing a digital copier with smart printing function according to a preferred embodiment of the invention. Referring to FIG. 1, the digital copier of this embodiment includes a tray module 10, a sheet size detection module 20, a quick copy button 30, a scanning module 40, a document size detector 50, an image processing module 60 and a printing module 70. The quick copy button 30 may be disposed on an operation panel of the digital copier, or on a lateral side of the digital copier. For the sake of clear illustration, the button 30 is disposed on the lateral side of the digital copier in this embodiment.

The tray module 10 stores a plurality of to-be-printed sheets S. In this embodiment, the tray module 10 includes two continuous trays 11 and 12, in which a lot of sheets can be placed and continuously fed, and one manual tray 13, in which one sheet or a few sheets can be placed. Two sets of to-be-printed sheets S with different sizes may be placed in the continuous trays 11 and 12, respectively. The to-be-printed sheets S may be placed in the manual tray 13. It is to be noted that there may be one continuous tray, or three or more than three continuous trays.

The sheet size detection module 20 detects a sheet size of each of the to-be-printed sheets S to generate a sheet size signal, such as an A4 or A3 sheet size signal. For example, sheet size detectors 21 and 22 are respectively disposed in the continuous trays 11 and 12, and a sheet size detector 23 is disposed in the manual tray 13. The quick copy button 30 is pressed by a user to generate a quick copy signal. The scanning module 40 scans a document P to obtain a document image and an image signal corresponding to the document image. The document P may also be fed by an automatic document feeder such that the scanning module 40 can scan the document P. The document size detector 50 detects a document size of the document P to obtain a document size signal, such as an A4 or A3 sheet size signal. The image processing module 60 processes the document image into a first image to fit the sheet size by way of scaling or into a second image to fit the sheet size by way of rotating and scaling according to the quick copy signal, the sheet size signal, the image signal and the document size signal, and thus generates a printing signal, which will be described later. The printing module 70 receives the printing signal to print the first or second image on the to-be-printed sheet S, which is then outputted to a sheet output tray 80. It is to be noted that the document size detector 50 may be omitted. In this case when the detector 50 is omitted, the image processing module 60 can generate the document size signal by way of edge finding according to the image signal.

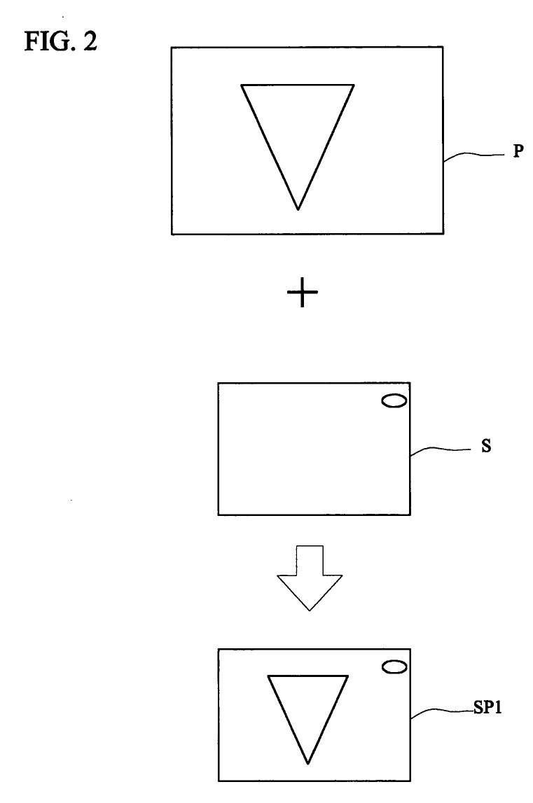

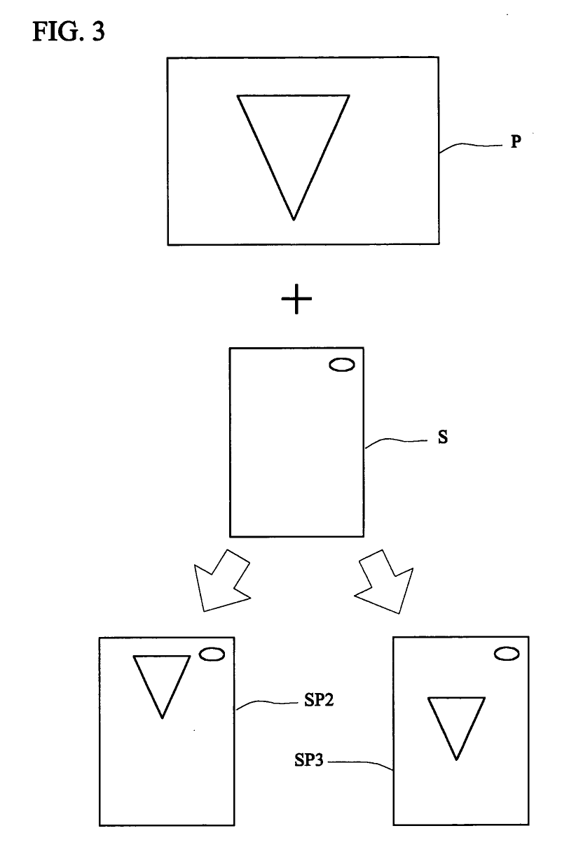

FIGS. 2 to 4 are schematic illustrations showing first to third examples of the digital copier of the invention during the copying process. As shown in FIG. 2, if the document P has the A3 size and is placed transversally and the to-be-printed sheet S has the A4 size and is placed transversally, the image processing module 60 scales down the A3-sized image by 297/420 times to form the A4-sized first image, which is then printed to obtain the printed document SP1. As shown in FIG. 3, if the document P has the A3 size and is placed transversally and the to-be-printed sheet S has the A4 size and is placed longitudinally, the image processing module 60 scales down the A3-sized image by 0.5 times, and prints out the printed document SP2 by placing the scaled first image on the top of the sheet, or prints out the printed document SP3 by placing the scaled first image at the middle of the sheet.

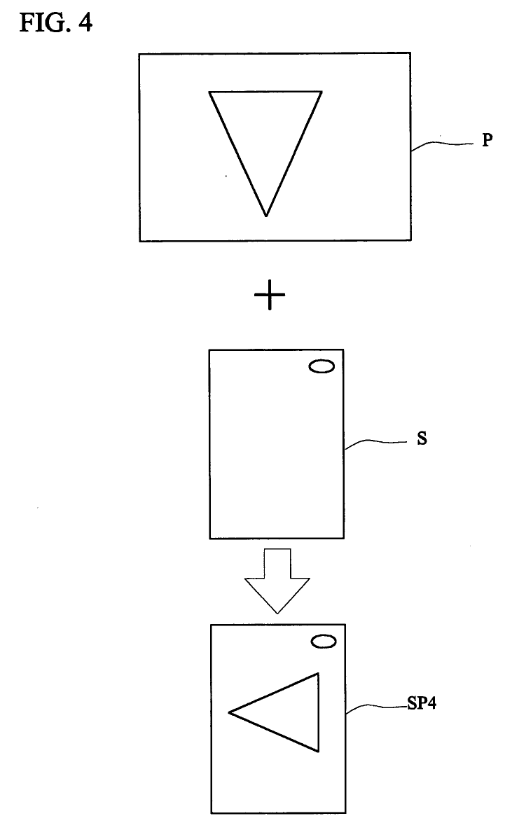

As shown in FIG. 4, if the document P has the A3 size and is placed transversally and the to-be-printed sheet S has the A4 size and is placed longitudinally, the image processing module 60 processes the document image into the second image to fit the sheet size by way of rotating and scaling according to the quick copy signal, the sheet size signal, the image signal and the document size signal, and thus generates the printing signal. That is, the image processing module 60 rotates the A3-sized image by 90 degrees, and scales down the rotated image by 297/420 times to obtain the A4-sized second image, which is printed out to obtain the printed document SP4.

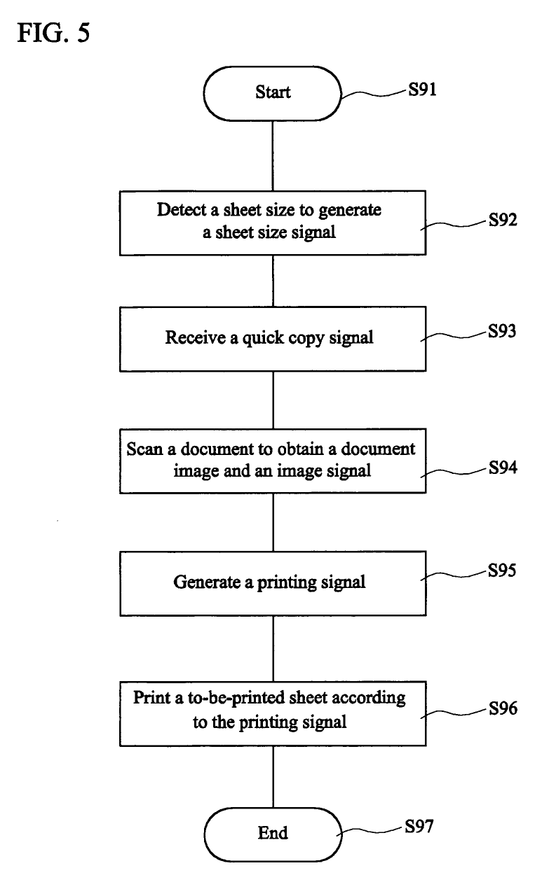

FIG. 5 is a flow chart showing a copying method of the digital copier of the invention. As shown in FIGS. 5 and 1, the copying method of the invention includes the following steps.

Step S91 starts.

Step S92 uses the sheet size detection module 20 to detect the sheet size and generate the sheet size signal. Specifically speaking, the sheet size detection module 20 detects the sheet size of each of the to-be-printed sheets placed in the tray module 10 to generate the sheet size signal.

Step S93 receives the quick copy signal, which is generated when the user has pressed the quick copy button 30.

Step S94 uses the scanning module 40 to scan the document to obtain the document image and the image signal corresponding to the document image.

Step S95 generates the printing signal. Specifically speaking, this step uses the image processing module 60 to process the document image into the first image to fit the sheet size by way of scaling or into the second image to fit the sheet size by way of rotating and scaling according to the quick copy signal, the sheet size signal, the image signal and the document size signal, and thus to generate the printing signal. The document size signal may be obtained by detecting the document size of the document, or may be generated according to the image signal, as mentioned hereinabove. Thus, the copying method may further include a step of generating the document size signal before step S95.

Step S96 prints out the to-be-printed sheet according to the printing signal. Specifically speaking, this step utilizes the printing module 70 to receive the printing signal and to print the first image or the second image on the to-be-printed sheet.

Step S97 ends.

According to the digital copier of the invention, the user can press the single quick copy button to achieve the smart copy function. Of course, the digital copier may also have other buttons for selecting the sheet size and adjusting the scaling ratio, and a typical copy button. In addition, the digital copier may also judge whether or not a suitable sheet with the suitable size exists and can be printed. If the suitable sheet exists, the data is directly printed without rotating and scaling. If the suitable sheet does not exist, the image is rotated and/or scaled and then printed out. The quick copy button can bring a great convenience for the user because the user can perform the smart copy by only pressing the button once. Thus, the intention of the user of using the digital copier can be enhanced, and the digital copier of the invention can be popularized.

While the invention has been described by way of examples and in terms of preferred embodiments, it is to be understood that the invention is not limited to the disclosed embodiments. To the contrary, it is intended to cover various modifications. Therefore, the scope of the appended claims should be accorded the broadest interpretation so as to encompass all such modifications.

What is claimed is:

1. A digital copier, comprising:
a tray module for storing a plurality of to-be-printed sheets;
a sheet size detection module for detecting a sheet size of each of the to-be-printed sheets and thus generating a sheet size signal;
a quick copy button for generating a quick copy signal after being pressed;
a scanning module for scanning a document to obtain a document image and an image signal corresponding to the document image;
an image processing module for processing the document image into a first image to fit the sheet size by way of scaling or into a second image to fit the sheet size by way of rotating and scaling according to the quick copy signal, the sheet size signal, the image signal and a document size signal, and thus generating a printing signal; and
a printing module for receiving the printing signal to print the first image or the second image on the to-be-printed sheet.

2. The copier according to claim 1, wherein the tray module comprises:
a manual tray, in which the to-be-printed sheets may be placed; and
a continuous tray, in which the to-be-printed sheet may be placed.

3. The copier according to claim 1, wherein the tray module comprises:
a manual tray, in which the to-be-printed sheets may be placed; and
two continuous trays, in which two sets of the to-be-printed sheets with different sizes may be placed.

4. The copier according to claim 1, further comprising a document size detector for detecting a document size of the document to obtain the document size signal.

5. The copier according to claim 1, wherein the image processing module generates the document size signal according to the image signal.

6. A method of a digital copier with smart printing function, the method comprising the steps of:
detecting a sheet size of each of to-be-printed sheets placed in a tray module to generate a sheet size signal;
receiving a quick copy signal generated after a quick copy button has been pressed;
scanning a document to obtain a document image and an image signal corresponding to the document image;
processing the document image into a first image to fit the sheet size by way of scaling or into a second image to fit the sheet size by way of rotating and scaling according to the quick copy signal, the sheet size signal, the image signal and a document size signal, and thus generating a printing signal; and
receiving the printing signal to print the first image or the second image on the to-be-printed sheet.

7. The method according to claim 6, further comprising the step of:
detecting a document size of the document to obtain the document size signal.

8. The method according to claim 6, further comprising the step of:
generating the document size signal according to the image signal.
